(19) United States
(12) Patent Application Publication
(10) Pub. No.: US 2021/0091926 A1
(43) Pub. Date: Mar. 25, 2021

(54) ASSESSING PERMISSIONED BLOCKCHAINS

(71) Applicant: The MITRE Corporation, McLean, VA (US)

(72) Inventors: Venkatesh RAMASWAMY, Westford, MA (US); David R. PENNY, Braintree, MA (US)

(73) Assignee: The MITRE Corporation, McLean, VA (US)

(21) Appl. No.: 16/582,396

(22) Filed: Sep. 25, 2019

(51) Int. Cl. H04L 9/06; H04L 9/32; G06F 11/07

(52) U.S. Cl. CPC H04L 9/0637; H04L 2209/38; G06F 11/0709; H04L 9/3236

(57) ABSTRACT

Described are systems and methods for analytically assessing a permissioned blockchain network implementing a Practical Byzantine Fault Tolerance (PBFT) based consensus protocol. In some embodiments, a method includes receiving, from a user, a plurality of values corresponding to a plurality of network parameters specifying network constraints in the permissioned blockchain network. A stochastic model is configured with the plurality of values and includes a plurality of probability mass functions (PMFs) corresponding to a plurality of phases of the PBFT-based consensus protocol. Each PMF represents a probability distribution of numbers of validating nodes successfully receiving messages from validating nodes in a previous phase. The method further includes executing the stochastic model to quantify a plurality of metrics measuring a performance of the PBFT-based consensus protocol and providing a performance assessment of applying the PBFT-based consensus protocol in the permissioned blockchain network based on the plurality of quantified metrics.

### FIELD OF THE DISCLOSURE

The present disclosure relates generally to systems and methods for assessing permissioned blockchains and in particular, assessing a performance of a permissioned blockchain under network constraints.

### BACKGROUND OF THE DISCLOSURE

Blockchain is a digital ledger that can be used to record secure and trustworthy transactions in a distributed network. Generally, the blockchain can be implemented as a growing list of records (i.e., blocks) that are linked using cryptography. The blockchain is typically managed by a peer-to-peer network that collectively adheres to a selected protocol for inter-node communication and validating new blocks. Though blockchains were initially applied in the financial domain and used in crypto-currencies, their application is rapidly expanding into diverse domains including governmental, supply chain management, and industrial sectors.

Blockchains are generally operated in one of the two different models: permissionless or permissioned. In a permissionless (sometimes referred to as public) model, any participant node (also referred to as peer) is allowed to join the distributed system without an authentication mechanism. Bitcoins and its variants are examples of permissionless blockchains. Permissioned (sometimes referred to as consortium or private) blockchains, on the other hand, require a priori authentication of peers before they can join the distributed system. Therefore, every peer node in the system is known to every other peer.

The peer nodes (for e.g., a consortium of banks), however, do not trust each other and a consensus process is required for execution of transactions in a finite amount of time. In essence, permissioned blockchains are operated with known and identified participants in a controlled environment. Many permissioned blockchains today implement a Practical Byzantine Fault Tolerant (PBFT) based consensus protocol as the consensus process due its efficiency and scalability as well as its ability to tolerate Byzantine faults, as will be further explained below.

Permissioned blockchains are highly suitable for enterprise applications, but require strict performance guarantees in terms of the execution time and system throughput. These performance guarantees are difficult to achieve in a system that operates in a distributed fashion. For example, in several domains such as Internet of Things and government/military use cases, the distributed networks may in implemented in constrained environment with intermittent network connectivity and/or low link bandwidth (which consequently results in large link latencies). These varying network constraints can induce undesirable effects and reduce the reliability of permissioned blockchains. Moreover, network constraints can induce failure in the permissioned blockchain. Blockchain network architects need to understand how network constrains in the distributed network may impact the permissioned blockchain to design robust blockchain networks that meet strict performance requirements.

### SUMMARY OF THE DISCLOSURE

As discussed above, users such as blockchain network architectures need to understand how network constraints would impact a permissioned blockchain implementing a consensus protocol in order to design and build robust permissioned networks. Accordingly, there is a need for systems, methods, and computer program embodiments to analytically assess a performance of permissioned blockchains given network constraints.

In some embodiments, a computer-implemented method for analytically assessing a permissioned blockchain network implementing a Practical Byzantine Fault Tolerance (PBFT) based consensus protocol includes receiving, from a user, a plurality of values corresponding to a plurality of network parameters specifying network constraints in the permissioned blockchain network. Then, a stochastic model is configured with the plurality of values. The stochastic model can include a plurality of probability mass functions (PMFs) corresponding to a plurality of sequential phases of the PBFT-based consensus protocol, where each PMF represents a probability distribution of numbers of validating nodes successfully receiving messages from validating nodes in a previous phase.

By providing these PMFs in the stochastic model, the method allows for “what-if” scenarios to be assessed to determine how certain network constraints would impact the performance and robustness of the permissioned blockchain network. In some embodiments, the method further includes executing the stochastic model to quantify a plurality of metrics measuring a performance of the PBFT-based consensus protocol. Then, a performance assessment of applying the PBFT-based consensus protocol in the permissioned blockchain network based on the plurality of quantified metrics can be provided to the user.

In some embodiments of the method, the plurality of network parameters includes a number of validating nodes, a packet loss rate for data transfer between validating nodes, a maximum number of faulty validating nodes, and a link latency between validating nodes. In some embodiments, the plurality of network parameters includes a range of values for at least one network parameter.

In some embodiments of the method, the plurality of metrics includes an average number of attempts to reach a consensus within the permissioned blockchain network, an average amount of time to reach the consensus, and an average number of transmitted messages to reach the consensus.

In some embodiments of the method, providing the performance assessment includes: receiving, from the user, one or more service requirements corresponding to one or more metrics from the plurality of metrics; selecting a plurality of values for a number of validating nodes in the permissioned blockchain network; for each selected value from the plurality of selected values, configuring and executing the stochastic model based on the selected value to quantify the plurality of metrics; and based on the quantified plurality of metrics for each selected value, outputting a minimum number of validating nodes required in the permissioned blockchain network to satisfy the one or more service requirements.

In some embodiments of the method, providing the performance assessment includes: receiving, from the user, one or more service requirements corresponding to one or more metrics from the plurality of metrics; receiving, from the user, a specified network parameter to be assessed by the stochastic model; selecting a plurality of values for the specified network parameter; for each value from the plurality of selected values, configuring and executing the stochastic model based on the selected value and the plurality of values corresponding to the plurality of network parameters to quantify the plurality of metrics; and based on the quantified plurality of metrics for each selected value, outputting a value for the specified network parameter required in the permissioned blockchain network to satisfy the one or more service requirements.

In some embodiments of the method, providing the performance assessment includes: generating a plurality of charts corresponding to the plurality of metrics, wherein each chart shows changes in the metric across a range of a number of validating nodes for a plurality of values for the specified network parameter; and displaying one or more of the plurality of charts.

In some embodiments, a system for analytically assessing a permissioned blockchain network implementing a Practical Byzantine Fault Tolerance (PBFT) based consensus protocol includes: one or more processors; a memory storing one or more programs that when executed by the one or more processors cause the one or more processors to: receive, from a user, a plurality of values corresponding to a plurality of network parameters specifying network constraints in the permissioned blockchain network; configure a stochastic model with the plurality of values, wherein the stochastic model comprises a plurality of probability mass functions (PMFs) corresponding to a plurality of sequential phases of the PBFT-based consensus protocol, wherein each PMF represents a probability distribution of numbers of validating nodes successfully receiving messages from validating nodes in a previous phase; execute the stochastic model to quantify a plurality of metrics measuring a performance of the PBFT-based consensus protocol; and provide a performance assessment of applying the PBFT-based consensus protocol in the permissioned blockchain network based on the plurality of quantified metrics.

In some embodiments of the system, the plurality of network parameters includes a number of validating nodes, a packet loss rate for data transfer between validating nodes, a maximum number of faulty validating nodes, and a link latency between validating nodes. In some embodiments, the plurality of network parameters includes a range of values for at least one network parameter.

In some embodiments of the system, the plurality of metrics includes an average number of attempts to reach a consensus within the permissioned blockchain network, an average amount of time to reach the consensus, and an average number of transmitted messages to reach the consensus.

In some embodiments of the system, to provide the performance assessment, the one or more processors are caused to: receive, from the user, one or more service requirements corresponding to one or more metrics from the plurality of metrics; select a plurality of values for a number of validating nodes in the permissioned blockchain network; for each selected value from the plurality of selected values, configure and execute the stochastic model based on the selected value to quantify the plurality of metrics; and based on the quantified plurality of metrics for each selected value, output a minimum number of validating nodes required in the permissioned blockchain network to satisfy the one or more service requirements.

In some embodiments of the system, to provide the performance assessment, the one or more processors are caused to: receive, from the user, one or more service requirements corresponding to one or more metrics from the plurality of metrics; receive, from the user, a specified network parameter to be assessed by the stochastic model; select a plurality of values for the specified network parameter; for each value from the plurality of selected values, configure and execute the stochastic model based on the selected value and the plurality of values corresponding to the plurality of network parameters to quantify the plurality of metrics; and based on the quantified plurality of metrics for each selected value, output a value for the specified network parameter required in the permissioned blockchain network to satisfy the one or more service requirements.

In some embodiments of the system, to provide the performance assessment, the one or more processors are caused to: generate a plurality of charts corresponding to the plurality of metrics, wherein each chart shows changes in the metric across a range of a number of validating nodes for a plurality of values for the specified network parameter; and display one or more of the plurality of graphs.

In some embodiments, a non-transitory computer-readable storage medium storing programming instructions that when executed by one or more processors causes the one or more processors to analytically assess a permissioned blockchain network implementing a Practical Byzantine Fault Tolerance (PBFT) based consensus protocol by: receiving, from a user, a plurality of values corresponding to a plurality of network parameters specifying network constraints in the permissioned blockchain network; configuring a stochastic model with the plurality of values, wherein the stochastic model comprises a plurality of probability mass functions (PMFs) corresponding to a plurality of sequential phases of the PBFT-based consensus protocol, wherein each PMF represents a probability distribution of numbers of validating nodes successfully receiving messages from validating nodes in a previous phase; executing the stochastic model to quantify a plurality of metrics measuring a performance of the PBFT-based consensus protocol; and providing a performance assessment of applying the PBFT-based consensus protocol in the permissioned blockchain network based on the plurality of quantified metrics.

In some embodiments of the computer-readable storage medium, the plurality of network parameters includes a number of validating nodes, a packet loss rate for data transfer between validating nodes, a maximum number of faulty validating nodes, and a link latency between validating nodes. In some embodiments, the plurality of network parameters includes a range of values for at least one network parameter.

In some embodiments of the computer-readable storage medium, the plurality of metrics includes an average number of attempts to reach a consensus within the permissioned blockchain network, an average amount of time to reach the consensus, and an average number of transmitted messages to reach the consensus.

In some embodiments of the computer-readable storage medium, providing the performance assessment includes: receiving, from the user, one or more service requirements corresponding to one or more metrics from the plurality of metrics; selecting a plurality of values for a number of validating nodes in the permissioned blockchain network; for each selected value from the plurality of selected values, configuring and executing the stochastic model based on the selected value to quantify the plurality of metrics; and based on the quantified plurality of metrics for each selected value, outputting a minimum number of validating nodes required in the permissioned blockchain network to satisfy the one or more service requirements.

In some embodiments of the computer-readable storage medium, providing the performance assessment includes: receiving, from the user, one or more service requirements corresponding to one or more metrics from the plurality of metrics; receiving, from the user, a specified network parameter to be assessed by the stochastic model; selecting a plurality of values for the specified network parameter; for each value from the plurality of selected values, configuring and executing the stochastic model based on the selected value and the plurality of values corresponding to the plurality of network parameters to quantify the plurality of metrics; and based on the quantified plurality of metrics for each selected value, outputting a value for the specified network parameter required in the permissioned blockchain network to satisfy the one or more service requirements.

In some embodiments of the computer-readable storage medium, providing the performance assessment includes: generating a plurality of charts corresponding to the plurality of metrics, wherein each chart shows changes in the metric across a range of a number of validating nodes for a plurality of values for the specified network parameter; and displaying one or more of the plurality of charts.

### BRIEF DESCRIPTION OF THE DRAWINGS

The foregoing summary, as well as the following detailed description of embodiments, is better understood when read in conjunction with the appended drawings. For the purpose of illustrating the present disclosure, the drawings show example embodiments of the disclosure; the disclosure, however, is not limited to the specific methods and instrumentalities disclosed. In the drawings:

FIG. 1 illustrates a diagram showing how a Practical Byzantine Fault Tolerant (PBFT) based consensus protocol operates within a permissioned blockchain network, according to some embodiments;

FIG. 2 illustrates a system diagram of a blockchain assessment application, according to some embodiments;

FIG. 3 illustrates a method for analytically assessing a permissioned blockchain network implementing a PBFT-based consensus protocols, according to some embodiments;

FIG. 4A illustrates a chart that shows the expected number of attempts to reach consensus for a number of tolerable faults across a range of validating nodes in the permissioned blockchain network, according to some embodiments;

FIG. 4B illustrates a chart that shows the expected number of attempts to reach consensus for a number of packet loss rates across a range of validating nodes in the permissioned blockchain network, according to some embodiments;

FIG. 5A illustrates a chart that shows the expected amount of time to reach consensus for a number of packet loss rates and a number of tolerable faults across a range of validating nodes in the permissioned blockchain network, according to some embodiments;

FIG. 5B illustrates a chart that shows the expected amount of time to reach consensus for a number of packet loss rates and a number of average link latencies across a range of validating nodes in the permissioned blockchain network, according to some embodiments;

FIG. 6 illustrates a chart that shows the expected number of transmitted messages to reach consensus for a number of packet loss rates across a range of validating nodes in the permissioned blockchain network, according to some embodiments;

FIG. 7 illustrates an example of a computing device, according to some embodiments.

### DETAILED DESCRIPTION

Described herein are systems and methods for analytically assessing a performance of a permissioned blockchain network under specified network constraints. The following description sets forth exemplary methods, parameters, and the like. It should be recognized, however, that such description is not intended as a limitation on the scope of the present disclosure but is instead provided as a description of exemplary embodiments.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

Certain aspects of the present invention may include process steps and instructions described herein in the form of an algorithm. It should be noted that the process steps and instructions of the present invention could be embodied in software, firmware, or hardware, and, when embodied in software, they could be downloaded to reside on, and be operated from, different platforms used by a variety of operating systems.

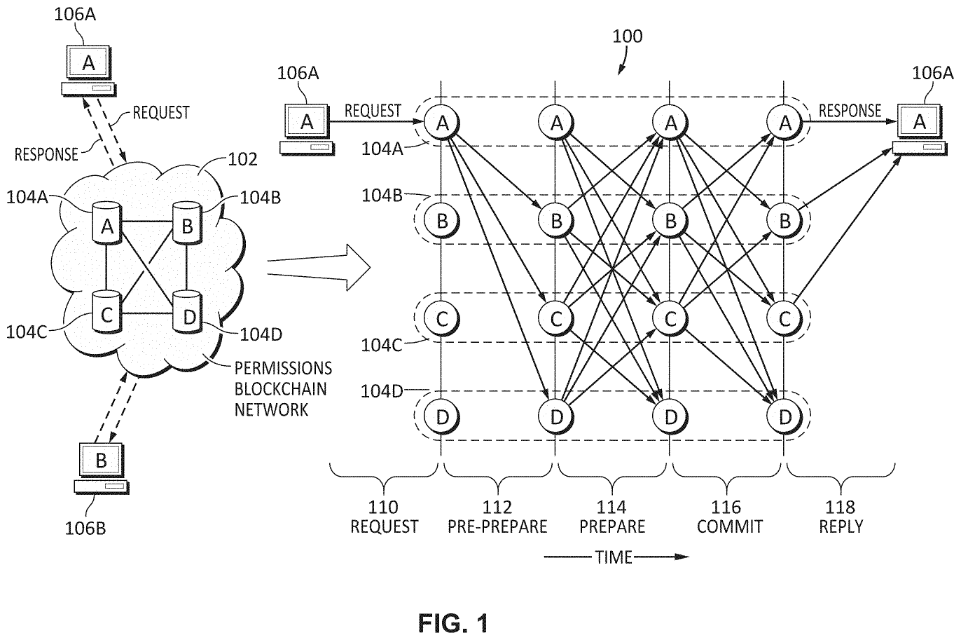

FIG. 1 illustrates a diagram 100 showing how a Practical Byzantine Fault Tolerant (PBFT) based consensus protocol operates within a permissioned blockchain network 102, according to some embodiments. In some embodiments, the PBFT-based consensus protocol can include a variation of the PBFT consensus protocol including, for example, Redundant BFT (RBFT), ABsTRACTs, Q/U, Hybrid Quorum (HQ) Protocol for BFT, Adapat, Zyzzyva-Speculative Byzantine Fault Tolerance, Aardvark, etc.

As discussed above, a permissioned blockchain network includes a network in which users cannot freely join the network, see recorded history, or issue transactions on their own. In some embodiments, only approved computer entities can run peer nodes in the blockchain network, validate transaction blocks, issue transactions, execute smart contracts, or read transaction history. As used in the disclosure herein, peer nodes may also be referred to as peers, validating nodes, or validating peers. As shown in FIG. 1, permissioned blockchain network 102 includes a plurality of validating nodes 104A-D (labeled A, B, C, and D). In some embodiments, clients 106A-B (labeled A and B) can submit transaction requests to and receive corresponding responses from one or more validating nodes 104A-D of permissioned blockchain network 102. A received response may indicate a status of a submitted transaction request.

In some embodiments, permissioned blockchain network 102 implements a PBFT-based consensus protocol used by validating nodes 104A-D to reach a common agreement about the present state of the blockchain such that every recorded transaction in the blockchain is secured and verified. For example, example variants of PBFT consensus protocol includes RBFT and PoET. As will further explained below, PBFT-based consensus protocols are often used because they can tolerate byzantine faults, which are caused when a validating node behaves maliciously or when there is either hardware or software error causing the validating node to behave in an unpredictable manner.

In some embodiments, the PBFT-based consensus protocol includes a plurality of phases. For example, diagram 100 shows that the PBFT-based consensus protocol implemented by permissioned blockchain network 102 includes three phases: pre-prepare phase 112, prepare phase 114, and commit phase 116, each of which will be further described below.

In some embodiments, each of clients 106A-B can be configured to transmit transaction requests to a set of designated validating nodes 104A-D. For example, as shown in diagram 100, client 106A may be configured to initiate and transmit a transaction request 110 to validating node 104A, which is designated as a primary node and is an example of a designated validating node.

In pre-prepare phase 112, validating node 104A, i.e., the primary validating node, generates a pre-prepare message and broadcasts the pre-prepare message to other validating nodes 104B-D in permissioned blockchain network 102. In some embodiments, the pre-prepare message includes information configured to enable the requested transaction, once verified, to be added to the blockchain. For example, the information may include a sequence number specifying an order of the transaction with respect to the blockchain.

In prepare phase 114, each of validating nodes 104B-D that receives the pre-prepare message from the primary validating node 104A can generate a respective prepare message to be broadcast to other validating nodes 104A-D. In some embodiments, a validating node that receives the pre-prepare message may process the pre-prepare message to verify its validity before generating the prepare message.

In some embodiments, to ensure safety against a first predetermined number of faults (f), in each phase, a validating node needs to receive at least a second predetermined number (i.e., 2f+1) of messages (including its own generated message) from the directly preceding phase before proceeding. Accordingly, a validating node in prepare phase 114 needs to receive at least the second predetermined number (i.e., 2f+1) of prepare messages from all validating nodes (including itself) before the validating node will enter the commit phase. For example, the PBFT-based consensus protocol shown in diagram 100 may tolerate 1 fault and validating nodes 104A-C each received four prepare messages including its respectively generated prepare message and prepare messages from the other validating nodes. Therefore, validating nodes 104A-D will continue to commit phase 116 because they have received the second predetermined number of prepare messages (i.e., 4>2f+1 where f=1).

In commit phase 116, a validating node can be configured to execute the transaction request and send a result of processing one or more received prepare messages. Like in prepare phase 114, a validating node can be configured to generate a commit message and broadcast the generated commit message to other validating nodes if the validating node receives at least the second predetermined number (i.e., 2f+1) of messages (including its own generated prepare message) from the previous prepare phase. The commit message may include a result of executing the transaction request, according to some embodiments.

In some embodiments, a validating node can be configured to commit the transaction locally and transmit a response message in reply phase 118 back to client 106A if it receives at least the second predetermined number of commit messages (including its own commit message). For example, validating nodes 104A-C each received three commit message (including their own respective commit messages) and will, therefore, commit the transaction locally and transmit reply messages in reply phase 118. As shown in diagram 100, validating node 104D may have encountered an error and did not generate and transmit a commit message. Therefore, validating node 104D did not generate and transmit a reply message. However, the PBFT-based consensus protocol can still proceed while tolerating the one faulty validating node D.

In some embodiments, client 106A needs to receive at least the second predetermined number (i.e., 2f+1) of reply messages before the transaction can be validated. In some embodiments, client 106A can be configured to start a timer after transmitting request 110 and upon expiry of the timer without receiving the second predetermined number of reply messages, client 106A can resubmit transaction request 110. In some embodiments, the timeout value specified by the timer may be a predefined amount of time that may be configured by a user. In some embodiments, client 106A can abandon the transaction upon retransmitting the transaction a predefined number of instances.

In some embodiments, the PBFT-based consensus protocol can implement a gossip process in which messages in the prepare and commit phases can be rebroadcasted at a predetermined periodicity. Adding the gossip process may not be desirable in network constrained environments (e.g., low bandwidth or long link latencies) due to the significantly number of overhead messages that would be introduced in the permissioned blockchain network, according to some embodiments.

From the example permissioned blockchain network 102 and implemented PBFT-based consensus protocol shown in diagram 100, it can be seen that it would be important and helpful for a user (e.g., a network architect or engineer) to understand how network constraints would effect a performance of permissioned blockchain network 102. For example, in a network environment with high packet loss (e.g., unreliable or low network connectivity), the user may need to know how many validating nodes 104A-D are required in permissioned blockchain network 102 to tolerate a preselected number of faults (e.g., 1, 2, or 3).

In another example, permissioned blockchain network 102 may be used for a military or enterprise application, which may require certain service requirements such as a maximum amount of time to reach consensus. In a network environment with high packet loss, client 106A may need to retransmit many transaction requests before consensus is reached, resulting in unacceptable amounts of processing time. In this scenario, the user may need to know whether permissioned blockchain network 102 being considered would meet service requirements given a set of network constraint parameters.

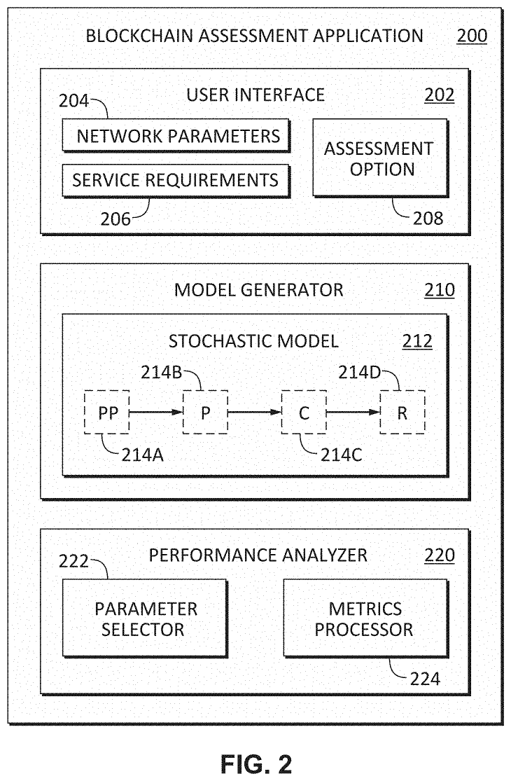

FIG. 2 illustrates a system diagram of a blockchain assessment application 200, according to some embodiments. In some embodiments, blockchain assessment application 200 can include a software application or a web application implemented on a computing device such as a desktop computer, a laptop, a server, etc. As will be further described below, blockchain assessment application 200 can be configured to assess a performance of a permissioned blockchain network such as permissioned blockchain network 102 to help a user, e.g., a network engineer or architect, better design and implement a robust permissioned blockchain network needed in enterprise, military, and government applications. For ease of explanation, the following descriptions may refer to permissioned blockchain network 102 and operations of a PBFT-based consensus protocol shown in diagram 100 of FIG. 1.

In some embodiments, to provide a performance assessment of the permissioned blockchain network, blockchain assessment application 200 can include the following components: user interface 202, model generator 210, and performance analyzer 220. In some embodiments, each component can include a set of programming instructions, stored in memory, that when executed by one or more processors cause the one or more processors to perform the operations dictated by the programming instructions.

In some embodiments, user interface 202 can be configured to prompt the user to enter inputs for network parameters 204, service requirements 206, and assessment options 208. In some embodiments, values for network parameters 204 received by user interface 202 enables blockchain assessment application 200 to generate and execute a stochastic analytical model that represents the permissioned blockchain network implementing the PBFT-based consensus protocol. In some embodiments, values for service requirements 206 received by user interface 202 enables blockchain assessment application 200 to determine if the permissioned blockchain network being considered will be robust enough to achieve required service requirements under specified network constraints. In some embodiments, selections for assessment options 208 received by user interface 202 controls how blockchain assessment application 200 provides the performance assessment of the permissioned blockchain network, as will be further described below.

In some embodiments, network parameters 204 can include a plurality of network constraints, a plurality of blockchain network parameters, or a combination thereof. In some embodiments, the plurality blockchain network parameters include a number of validating nodes in the permissioned blockchain network and a maximum fault tolerance (e.g., a maximum number of faulty validating nodes). In some embodiments, the plurality of network parameters can include one or more of a packet loss rate (e.g., a percentage) for data transfer between validating nodes, a link bandwidth, or a link latency between validating nodes. In some embodiments, the plurality of network parameters include at least the packet loss rate and the link latency.

For example, user interface 202 may receive user inputs indicating 40 validating nodes, a packet loss rate of 20%, a maximum number of faults as 5, and a link latency of 10 ms. Based on these inputs, model generator 210 may, for example, configure and execute stochastic model 212 to determine an expected consensus time of 2 s and a number of expected transmitted requests as 20 to reach consensus in the permissioned blockchain network. As explained with respect to diagram 100, client 106A may need to retransmit request 110 multiple times before it receives enough reply messages in reply phase 118 indicating that request 110 has been validated. Additionally, if client 106A needs to retransmit request 110, many additional messages including prepare, commit, and reply messages will need to be transmitted before consensus can be reached. These additional messages increase overhead and takes up valuable bandwidth in network-constrained environments with limited bandwidth.

In some embodiments, service requirements 206 can include required values for a plurality of metrics quantifying performance of the permissioned blockchain network implementing the PBFT-based consensus protocol. In some embodiments, the plurality of metrics can include a number of attempts (i.e., retransmitted transaction requests) to reach a consensus within the permissioned blockchain network, an amount of time to reach the consensus, and a number of transmitted messages to reach consensus in the permissioned blockchain network. In some embodiments, service requirements 206 can include a value for a metric and an associated quantity specifying a percentage of observed values that satisfies the value for the metric. For example, the user may input 2 seconds for the amount of time to reach consensus and input 65% indicating that the permissioned blockchain network being implemented needs to reach consensus within 2 seconds 65% of the time. In some embodiments, the default quantity specifying the percentage may be 50% indicating an average. For example, the user may input 2 seconds indicating that the permissioned blockchain network needs to reach consensus within an average of 2 seconds.

In some embodiments, user interface 202 can be configured to prompt the user to enter a range of values for one or more inputs including network parameters 204. For example, user interface 202 may receive a range of values (e.g., 10%-40%) for a packet loss rate, which is an example network parameter. In some embodiments, user interface 202 can prompt the user to enter a distribution of values for one or more inputs including network parameters or service requirements 206. For example, the user may input a probability distribution of link latencies as one of network parameters 204.

In some embodiments, assessment option 208 can include one or more inputs from the user that control how blockchain assessment application 200 assess and reports the determined performance of the permissioned blockchain network being considered given network parameters 204 to achieve service requirements 206. In some embodiments, assessment option 208 can include a selection for one or more variables to be solved given the inputted network parameters 204 and service requirements 206. For example, the user may input a number of requested nodes as an assessment option 208 to achieve consensus within an average of 1.5 seconds (i.e., an example of service requirement 206) if the packet loss in the permissioned blockchain network being implemented is 1% (i.e., an example of network parameters 204).

In some embodiments, assessment option 208 may include a selection to display results (e.g., a graph) showing performance of the permissioned blockchain network under consideration for a range of values for one or more of network parameters 204. For example, the user may enter inputs in assessment option 208 that control blockchain assessment application 200 to output a graph showing an average time to reach consensus (i.e., an example service requirement 206) for packet loss rates ranging from 1% to 10% (i.e., an example input for network parameters 204).

In some embodiments, assessment option 208 can include a selection specifying a type of the PBFT-based consensus protocol to be implemented by the permissioned blockchain network. In some embodiments, upon receiving this selection, user interface 202 can be configured to prompt the user to enter additional blockchain network parameters related to the selected consensus protocol.

In some embodiments, assessment option 208 can include parameters that specify how stochastic model 212 is configured. For example, assessment option 208 may include selections for a model (e.g., a Bernoulli loss model) for modeling link latency in the permissioned blockchain. In another example, assessment option 208 may include selections that indicate how validating nodes within the permissioned blockchain network are connected. For example, the user may indicate fully connected validating nodes, as shown in permissioned blockchain network 102, or specify individual connections between validating nodes.

In some embodiments, model generator 210 can be configured to generate and execute a stochastic model 212 to represent operations (e.g., as shown in diagram 100 of FIG. 1) of a PBFT-based consensus protocol implemented by the permissioned blockchain network. In some embodiments, stochastic model 212 can include a plurality of probability mass functions (PMFs) 214A-D corresponding to a plurality of sequential phases of the PBFT-based consensus protocol. For example, PMFs 214A-D (e.g., P{Xᵣ=i}, P{X_{c}=j}, P{Xₚ=k}, and P{Xₚₚ=l}) may correspond to the pre-prepare 112, prepare 114, commit 116, and reply 118 phases of the PBFT-based consensus protocol shown in diagram 100 of FIG. 1. In some embodiments, each of PMFs 214A-D represents a probability distribution of numbers of validating nodes successfully receiving messages from validating nodes in a directly preceding phase.

In some embodiments, the permissioned blockchain network can include N validating nodes (also referred to as validating peers), which are fully connected (i.e., each node has a direct link to N−1 other nodes). In some embodiments, for each link between validating nodes, stochastic model 212 can apply an independent Bernoulli loss model with a probability of 1−p for packet losses. Random variables can be configured to represent a number of nodes that received messages from the previous phase of the PBFT-based consensus protocol. For example, Xpp may be an random variable representing the number of nodes that received the prep-prepare message, Xp be the random variable representing the number of nodes that received the pre-prepare message as well as 2f+1 or more prepare messages, Xc be the random variable representing the number of nodes that received 2f+1 or more commit messages, and Xr be the random variable representing the number of reply messages received by the client. Then, a PMF (e.g., PMF 214A) for the pre-prepare phase can represent the probability that Xpp equals i, where i=0, . . . , N. In some embodiments, each of PMF 214A-D can be configured to condition on the random variable representing the number of nodes at the pervious phase.

For a PBFT-based consensus protocol having four phases (e.g., reply, commit, prepare, and pre-prepare phases), detailed descriptions of the plurality of probability mass functions are provided below.

TABLE 1

| Functions | Equation | Label |
|---|---|---|
| P{Xᵣ = i} | $ℙ \{ {X}_{r} = i \} = {\sum }_{j = i}^{N} ℙ \{ {X}_{r} = i \vert {X}_{c} = j \} ℙ \{ {X}_{c} = j \}$ | Equation (1) |
| P{X_{c} = j} | $ℙ \{ {X}_{c} = j \} = {\sum }_{k = j}^{N} ℙ \{ {X}_{c} = i \vert {X}_{p} = k \} ℙ \{ {X}_{p} = k \}$ | Equation (2) |
| P{Xₚ = k} | $ℙ \{ {X}_{p} = k \} = {\sum }_{l = k}^{N} ℙ \{ {X}_{p} = k \vert {X}_{pp} = l \} ℙ \{ {X}_{pp} = l \}$ | Equation (3) |
| P{Xₚₚ = l} | $ℙ \{ {X}_{pp} = l \} = ( \begin{matrix}N \\ l\end{matrix} ) {{p}^{l} ( 1 - p )}^{N - l}$ | Equation (4) |

In some embodiments, PMF 214A, P{Xₚₚ=l} is configured based on using the Bernoulli loss model, as shown in Equation (4) above. In some embodiments, other loss models can be used depending on assessment option 208 and Equation (4) would reflect the selected loss model. In some embodiments, PMFs 214A-D can be implemented as software functions or subroutines. As shown in Table 1, one or more of PMFs 214A-D may be implemented as iterative functions, according to some embodiments.

For example, Equation (1) for P{Xᵣ=i} is conditioned on P{X_{c}=j} shown in Equation (2), which is further conditioned on P{Xₚ=k} shown in Equation (3), etc. In some embodiments, PMF 214D for P{Xᵣ=i} can be presented as a iterative function by substituting Equations (4) in (3), (3) in (2), and (2) in (1) as shown in Equation (5) below:

$$ℙ \{ {X}_{r} = i \} = \{ {\sum }_{j = i}^{N} ℙ \{ {X}_{r} = i \vert {X}_{c} = j \} \{ {\sum }_{k = j}^{N} ℙ \{ {X}_{c} = i \vert {X}_{p} = k \} \{ {\sum }_{l = k}^{N} ℙ \{ {X}_{p} = k \vert {X}_{pp} = l \} ( \begin{matrix}N \\ l\end{matrix} ) {{p}^{l} ( 1 - p )}^{N - l} \} \} \} \qquad Equation ( 5 )$$

In some embodiments, when the Bernoulli loss model is selected by the user as assessment option 208, model generator 210 can be configured to apply and execute the loss model, a shown in Equation (4). In some embodiments, the following Table 2 mathematically shows the computations performed by model generator 210 to compute the conditional probabilities shown in Equation (5) where:

$${α}_{k} = {\sum }_{m = 2 f + 1}^{k} ( \begin{matrix}k \\ m\end{matrix} ) {{p}^{m} ( 1 - p )}^{k - m} and {α}_{l} = {\sum }_{m = 2 f + 1}^{l} ( \begin{matrix}l \\ m\end{matrix} ) {{p}^{m} ( 1 - p )}^{l - m}$$

TABLE 2

| Functions | Equation | Label |
|---|---|---|
| P{Xᵣ = i \| X_{c} = j} | $ℙ \{ {X}_{r} = i \vert {X}_{c} = j \} = ( \begin{matrix}j \\ i\end{matrix} ) {{p}^{i} ( 1 - p )}^{j - i}$ | Equation (6) |
| P{X_{c} = j \| Xₚ = k} | $ℙ \{ {X}_{c} = j \vert {X}_{p} = k \} = ( \begin{matrix}k \\ j\end{matrix} ) {{α}_{k}^{j} ( 1 - {α}_{k} )}^{k - j}$ | Equation (7) |
| P{Xₚ = k \| Xₚₚ = l} | $ℙ \{ {X}_{p} = k \vert {X}_{pp} = l \} = ( \begin{matrix}l \\ k\end{matrix} ) {{α}_{l}^{i} ( 1 - {α}_{l} )}^{j - i} .$ | Equation (8) |
| P{Xᵣ = i} | $\begin{matrix}ℙ \{ {X}_{r} = i \} = \{ {\sum }_{j = i}^{N} ( \begin{matrix}j \\ i\end{matrix} ) {{p}^{i} ( 1 - p )}^{j - i} \} \\ \{ {\sum }_{k = j}^{N} ( \begin{matrix}k \\ j\end{matrix} ) {{α}_{k}^{j} ( 1 - {α}_{k} )}^{k - j} \} \\ \{ {\sum }_{l = k}^{N} ( \begin{matrix}l \\ k\end{matrix} ) {{α}_{l}^{i} ( 1 - {α}_{l} )}^{j - i} \} \\ ( \begin{matrix}N \\ l\end{matrix} ) {{p}^{l} ( 1 - p )}^{N - l} \} \} \}\end{matrix}$ | Equation (9) |

As shown in Equation 9, which substitutes Equations (6) to (8) in (5), model generator 210 may iteratively compute the PMF 214D corresponding to P{Xᵣ=i}.

In some embodiments, performance analyzer 220 can include parameter selector 222 and metrics processor 224 to assess a performance of the permissioned blockchain network. In some embodiments, parameter selector 222 can set parameters of stochastic model 212 based on user inputs received for network parameters 204. In some embodiments, parameter selector 222 can be configured to allow the user to perform what-if analysis on the stochastic model 212 representing the permissioned blockchain network by executing stochastic model 212 many times according to one or more varying parameters. For example, stochastic model 212 may be executed 3 times where in each instance parameter selector 222 may select a different packet loss (e.g., 1%, 5%, and 10%).

In some embodiments, metrics processor 224 can be configured to execute stochastic model 212 based on parameters selected by parameter selector 222 to quantify metrics used to assess a performance of the permissioned blockchain network. In some embodiments, metrics processor 224 can be configured to compute a probability of successfully reaching consensus, P{S=1}=pₛ where S represents a Bernoulli random variable that takes a value of 1 if consensus is reached for any client request. In some embodiments, metrics processor 224 can generate the probability of success based on the predetermined number of tolerable faults (i.e., an example of network parameters 204 entered by the user) and the PMF for Xᵣ. Equation 10 below shows an example function providing pₛ:

$${p}_{s} = {{\sum }^{N}}_{i = f + 1} ℙ \{ {X}_{r} - i \} \qquad Equation ( 10 )$$

In some embodiments, based on one or more of Equations (1)-(10) implemented as one or more corresponding software functions, metrics processor 224 can be configured to generate a plurality of metrics quantifying a performance of the permissioned blockchain network implementing the PBFT-based consensus protocol. As discussed above, the plurality of metrics may include a number of attempts required to successfully reach consensus, a number of messages transmitted before reaching consensus, and/or an amount of time to reach consensus.

In some embodiments, metrics processor 224 can be configured to calculate the number of required attempts Nₛ to reach consensus based on the probability of successfully reaching consensus, as represented in Equation (10). In some embodiments, Nₛ can be a geometric random variable and metrics processor 224 can be configured to calculate the average number of required attempts to reach consensus as the inverse of the probability of successfully reaching consensus:

E[Ns]=pₛ⁻¹ Equation (11)

In some embodiments, metrics processor 224 can be configured to configure and execute a cumulative distribution function (F_{Ns}) of the number of attempts required to achieve consensus. One advantage of configuring this cumulative distribution function (F_{Ns}) is the capability to allow the user to specify service requirements in terms of distribution of percentiles instead of requiring the user to specify service requirements as averaged values. In some embodiments, metrics processor 224 can configure a probability density function of the number of attempts required for successful consensus according to the following equation:

[symbol]

{Nₛ=i}=pₛ(1−pₛ)^{t-1} Equation (12)

As discussed above with respect to Equation (10), the probability of successfully reaching consensus (pₛ) can be computed based on a packet loss probability of a link in the permissioned blockchain network. Then, metrics processor 224 can be configured to provide the cumulative distribution function (F_{Ns}) based on the following equation:

$${F}_{{N}_{s}} ( i ) = {\sum }_{j \leq i} ℙ \{ {N}_{s} = j \} \qquad Equation ( 13 )$$

In some embodiments, metrics processor 224 can be configured to calculate the required number of messages Nₘ transmitted before reaching consensus based on a number of transmitted messages for each attempt and a number of attempts before reaching consensus. For example, metrics processor 224 may calculate an average number of transmitted messages E[Nₘ] as the mean number of messages per attempt times the average number of attempts needed for a successful consensus, shown below as Equation (14):

$$\begin{matrix}𝔼 [ {N}_{m} ] = 𝔼 [ {N}_{s} ] 2 p ( {N}^{2} + N ) \\ = \frac{2 p}{{p}_{s}} ( {N}^{2} + N )\end{matrix} \qquad Equation ( 14 )$$

As shown in Equation (14), the total number of messages transmitted including successful and lost messages equals the sum of the number of messages transmitted at stage, which is 2(N²+N) where N is the total number of validating nodes. The mean number of messages is simply 2p(N²+N) where the link latency is p (i.e., the link loss is 1−p).

In some embodiments, metrics processor 224 can be configured to calculate an amount of time to reach consensus in the permissioned blockchain network implementing the PBFT-based consensus protocol. As described above, after client 106A transmits a transaction request to permissioned blockchain network 102, client 106A may start a timer. If a predetermined number (f+1) of reply messages (in the reply phase 118) are not received before the timer expires, then client 106A may be configured to retransmit request 110. In some embodiments, this process may be continued until a successful consensus is reached. In some embodiments, metrics processor 224 can determine an average amount of required time reach consensus, E[Tc], based on an average duration of a successful attempt, E[Ts], and the timeout value τ_{TO} representing a duration of every unsuccessful attempt, as shown below:

$$𝔼 [ {T}_{c} ] = \frac{1 - {p}_{s}}{{p}_{s}} {τ}_{TO} + 𝔼 [ {T}_{s} ] \qquad Equation ( 15 )$$

In some embodiments, the timeout value may be an example of one of network parameters 204 entered by the user. In other embodiments, the timeout value may be predetermined based on a selected type or version of the PBFT-based consensus protocol selected for the permissioned blockchain network.

In some embodiments, metrics processor 224 can be configured to run many iterations of stochastic model 212 in simulation to determine the average duration of a successful attempt E[Ts]. This approach may require hundreds or thousands of simulations, which is processor and time intensive. In other embodiments, metrics processor 224 can be configured to calculate an estimate of the average duration of a successful attempt E[Ts], as will be further described below. This approach does not require running stochastic model 212 through many iterations.

In some embodiments, metrics processor 224 can be configured to model the latency of each link (between validating nodes) in the permissioned blockchain network to behave according to an exponential distribution with parameter μ. In a synchronous operation at each phase, the average time for a successful attempt E[Ts] is the sum of the average time to complete each of the four phases. To compute the average time to finish each phase, metrics processor 224 can be configured to calculate the number of nodes at the beginning of each phase, according to some embodiments. In some embodiments, to further reduce computation complexity and time, metrics processor 224 can be configured to calculate the average number of nodes at the beginning of each phase. The following Table 3 illustrates how metrics processor 224 can be configured to calculate the number of nodes nₚₚ, nₚ, n_{c}, and nᵣ at the end of pre-prepare, prepare, commit, and reply phases, respectively:

TABLE 3

| Number of Nodes | Equation | Label |
|---|---|---|
| nₚₚ | nₚₚ = N p | Equation (16) |
| nₚ | ${n}_{p} = {n}_{pp} {\sum }_{i = {n}_{pp}}^{2 f + 1} ( \begin{matrix}{n}_{pp} \\ i\end{matrix} ) {{p}^{i} ( 1 - p )}^{{n}_{pp} - i} .$ | Equation (17) |
| n_{c} | ${n}_{c} = {n}_{p } {\sum }_{i = {n}_{p}}^{2 f + 1} ( \begin{matrix}{n}_{p} \\ i\end{matrix} ) {{p}^{i} ( 1 - p )}^{{n}_{p} - i}$ | Equation (18) |
| nᵣ | nᵣ = n_{c} p. | Equation (19) |

As discussed above, 1−p represents a packet loss probability of a link and p, therefore, represents a packet success rate of a link between validating nodes.

In some embodiments, metrics processor 224 can be configured to calculate the estimate of the average duration of a successful attempt E[Ts] by calculating a plurality of average durations of time τₚₚ, τₚ, τ_{c}, and τᵣ corresponding to a plurality of respective phases (e.g., pre-prepare, prepare, commit, and reply). In these embodiments, metrics processor 224 can calculate τₚₚ as the inverse of the exponential distribution parameter u and representing the average link latency. For a validating node to transition from the pre-prepare phase to the prepare phase, it must receive at least 2f+1 messages. Therefore, the average amount of time for transition from pre-prepare to prepare phase is the average amount of time it takes to receive 2f+1 message each with exponentially distributed latency and when nₚ messages are transmitted. In some embodiments, for Z₁, . . . , Znₚ be independent exponentially distributed random variables and Z(i) representing the i^{th} smallest of these random variables, then metrics processor 224 can calculate the expected value of Z(i) according to the following equation based on Equations (18) and (19):

$$𝔼 [ {Z}_{( i )} ] = \frac{1}{μ} {\sum }_{j = 0}^{i - 1} \frac{1}{{n}_{p} - j} \qquad Equation ( 20 )$$

Accordingly, metrics processor 224 can apply Equation (20) to determine each of τₚ, τ_{c}, and τᵣ according to the following Table 4:

TABLE 4

| Durations | Equation | Label |
|---|---|---|
| τₚₚ | tₚₚ = μ⁻¹ | Equation (21) |
| τₚ | ${τ}_{p} = \frac{1}{μ} {\sum }_{j = 0}^{2 f} \frac{1}{{n}_{pp} - j}$ | Equation (22) |
| τ_{c} | ${τ}_{c} = \frac{1}{μ} {\sum }_{j = 0}^{2 f} \frac{1}{{n}_{c} - j}$ | Equation (23) |
| τᵣ | ${τ}_{r} = \frac{1}{μ} {\sum }_{j = 0}^{f} \frac{1}{{n}_{r} - j}$ | Equation (24) |

Note that the upper limit summation of Equation (24) may be f because the client needs to receive responses from at least f+1 validating peers to successfully validate the transmitted request, according to some embodiments.

In some embodiments, metrics processor 224 can calculate an estimate of the average duration of a successful attempt E[Ts] by summing the calculated average durations of time τₚₚ, τₚ, τ_{c}, and τᵣ, as described and shown above with respect to Equations (21)-(24):

[symbol]

[Tₛ]≈τₚₚ+τₚ+τ_{c}+τᵣ Equation (25)

In some embodiments, instead of computing an average duration of a successful attempt E[Ts], metrics processor 224 can be configured to configure and execute a cumulative distribution function for the time to receive consensus. As discussed above, this approach enables service requirements 206 to be not in terms of average quantities but in percentages representing a confidence level for desired values.

In some embodiments, to compute this distribution, metrics processor 224 can be configured to generate a distribution model of the amount of time spent in unsuccessful attempts (denoted by Tᵤ) according to the following equation:

$${F}_{{T}_{u}} ( i ) = {\sum }_{j = 1}^{i} ℙ \{ {N}_{s} = j \} ( j - 1 ) {τ}_{TO} i \geq 1 \qquad Equation ( 26 )$$

In some embodiments, the probability density function of the number of attempts required for a successful consensus P{Ns=i} can be determined according to Equation (12) discussed above.

In some embodiments, metrics processor 224 can be configured to receive, from the user via user interface 202, Fₗ(x) and fₗ(x) representing the distribution and density of link latencies. In some embodiments, Fₗ(x) and fₗ(x) may be examples of network parameters 204. In some embodiments, metrics processor 224 can be configured to compute the time distributions for pre-prepare phase (τₚₚ), prepare phase (τₚ), commit phase (τ_{c}), and reply phase (τᵣ) based on Equations (12) and (26), as shown in Table 5 below:

TABLE 5

| Time | | |
|---|---|---|
| Distr. | Equation | Label |
| Fτₚₚ (x) | Fτₚₚ(x) = Fₗ(x) | Equation (27) |
| Fτₚ (x) | ${F}_{{τ}_{p}} ( x ) = {\sum }_{2 f + 1}^{{n}_{p}} ( \begin{matrix}{n}_{p} \\ 2 f + 1\end{matrix} ) {{F}_{l} ( x )}^{2 f + 1} {( 1 - {F}_{l} ( x ) )}^{{n}_{p} - 2 f - 1}$ | Equation (28) |
| Fτ_{c} (x) | ${F}_{{τ}_{c}} ( x ) = {\sum }_{2 f + 1}^{{n}_{c}} ( \begin{matrix}{n}_{c} \\ 2 f + 1\end{matrix} ) {{F}_{l} ( x )}^{2 f + 1} {( 1 - {F}_{l} ( x ) )}^{{n}_{c} - 2 f - 1}$ | Equation (29) |
| Fτᵣ (x) | ${F}_{{τ}_{r}} ( x ) = {\sum }_{f + 1}^{{n}_{r}} ( \begin{matrix}{n}_{r} \\ f + 1\end{matrix} ) {{F}_{l} ( x )}^{f + 1} {( 1 - {F}_{l} ( x ) )}^{{n}_{r} - f - 1}$ | Equation (30) |

In some embodiments, metrics processor 224 can be configured to determine the total time to consensus (T_{c}) based on the time spent in unsuccessful attempts (Tᵤ) plus the time spent in the successful attempt (Tₛ), i.e., T_{c}=Tᵤ+Tₛ. In some embodiments, the time spent in the successful attempt can be computed based on time in pre-prepare phase (τₚₚ), time in prepare phase (τp), time in commit phase (τc), and time in reply phase (τr), i.e., Tₛ=τₚₚ τp+τc+τr. In some embodiments, the distribution of Tᵤ as well as the distribution of each of the component that constitute Tₛ is described and shown above with respect to Equations (27)-(30).

Therefore, metrics processor 224 can be configured to determine the distribution of time to consensus based on a distribution of link latencies provided by the user. In some embodiments, the distribution of link latencies can be measured or estimated. In some embodiments, based on the distribution, metrics processor 224 can be configured to determine the distribution of the time to consensus based on standard techniques for simulating random variables from their distributions, i.e., distributions of τₚₚ, τp, τc, and τr show and described above with respect to Equations (27)-(30).

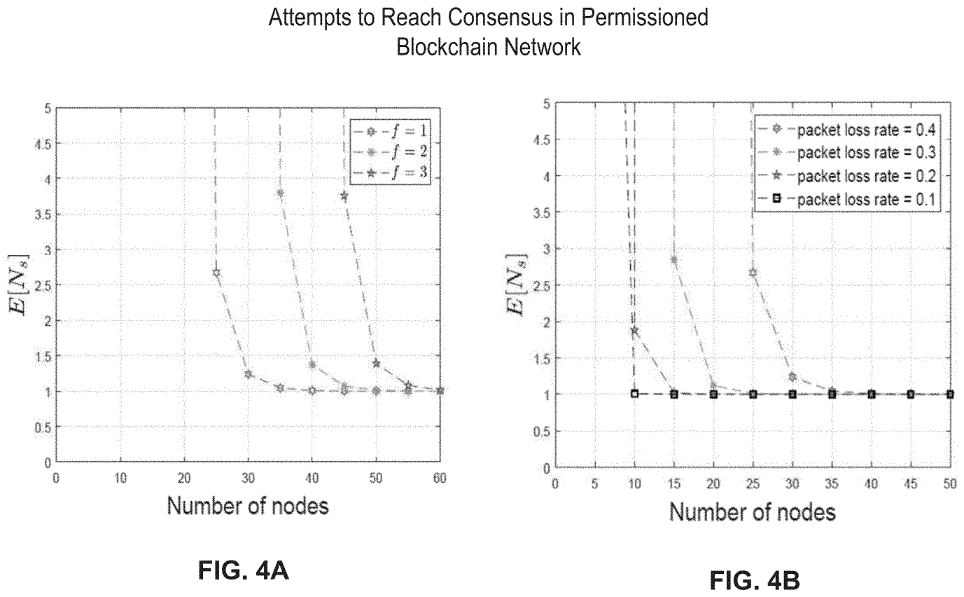

In some embodiments, metrics processor 224 can be configured to provide the assessed performance of the permissioned blockchain network as charts showing relationships between two or more network parameters 204 with respect to one or more service requirements 206, as will be further described below with respect to FIGS. 4A-B, 5A-B, and 6. In other embodiments, assessment option 208, selected by the user, may instruct metrics processor 224 to iteratively execute stochastic model 212 for a plurality of values for a first variable (e.g., a range of one of network parameters 204) across a plurality of validating nodes to notify the user of which combination of network parameters enables the user's input service requirements to be met. Based on a result provided by metrics processor 224, the user may need to improve a network infrastructure of the permissioned blockchain network under consideration, increase the number of validating nodes in the network, or use a different type of blockchain.

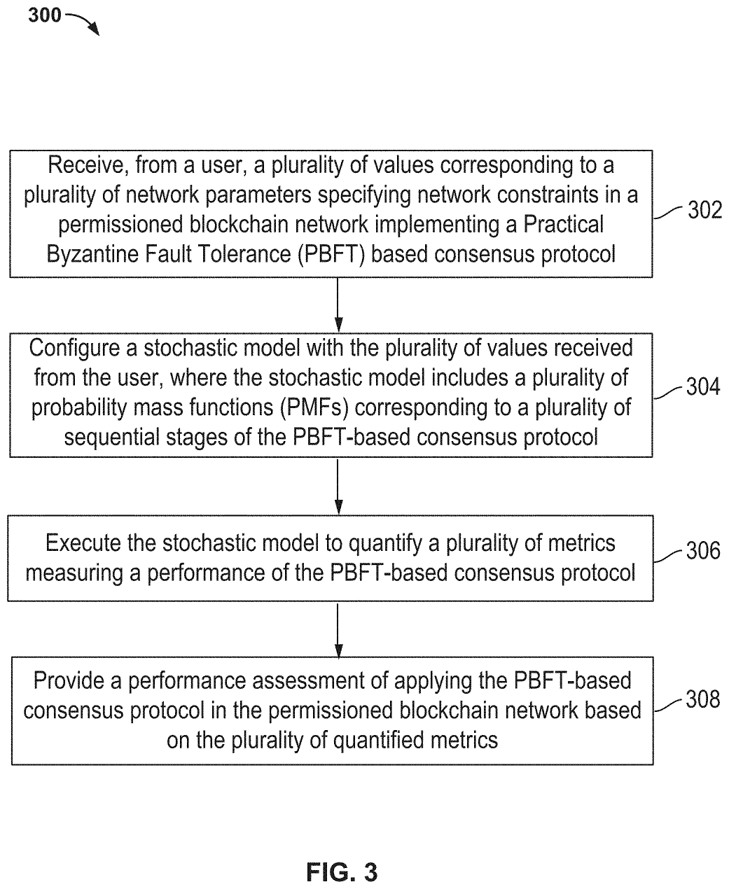

FIG. 3 illustrates a method 300 for analytically assessing a permissioned blockchain network that implements a Practical Byzantine Fault Tolerance (PBFT) based consensus protocol, according to some embodiments. In some embodiments, one or more steps of method 300 can be performed by an assessment system such as blockchain assessment application 200 as described above with respect to FIG. 2. In some embodiments, the assessment system can be a standalone software application, a web-based application, a mobile application, or a combination thereof. In some embodiments, the assessment system serves as a software tool that allows users (e.g., network engineers) to assess a robustness of an envisioned permissioned blockchain network that implements the PBFT-based consensus protocol.

In step 302, the assessment system (e.g., user interface 202) receives, from a user, a plurality of values corresponding to a plurality of network parameters specifying network constraints in the permissioned blockchain network. In some embodiments, the plurality of network parameters include one or more of a number of validating nodes, a packet loss rate for data transfer between validating nodes, a maximum number of faulty validating nodes, and a link latency between validating nodes.

In some embodiments, the assessment system prompts the user to input a range of values for at least one network parameter. In some embodiments, the assessment system enables the user to select one or more network parameters and to input one or more ranges for each of the one or more selected network parameters. In some embodiments, the assessment system enables the user to select one or more network parameter whose values are to be varied.

In step 304, the assessment system (e.g., model generator 210) configures a stochastic model with the plurality of values received from the user. In some embodiments, the stochastic model is configured to include a plurality of probability mass functions (PMFs) corresponding to a plurality of sequential phases of the PBFT-based consensus protocol, as described above with respect to stochastic model 212. In some embodiments, each PMF represents a probability distribution of numbers of validating nodes successfully receiving messages from validating nodes in an immediate previous phase. For example, a PMF for the prepare phase represents the probability distribution of numbers of validating nodes successfully receiving messages from validating nodes in the pre-prepare phase.

In step 306, the assessment system (e.g., performance analyzer 220) executes the stochastic model to quantify a plurality of metrics measuring a performance of the PBFT-based consensus protocol. In some embodiments, the plurality of metrics includes one or more of a number of attempts to reach a consensus within the permissioned blockchain network, an amount of time to reach the consensus, and a number of transmitted messages to reach the consensus.

In some embodiments, the plurality of quantified metrics include an average quantity for each metric. For example, a quantified metric may be an average number of attempts to reach consensus, an average amount of time to reach the consensus, or an average number of transmitted messages to reach the consensus. In some embodiments, the plurality of quantified metrics include a quantity representing a predetermined percentile of observed values for each metric. For example, a quantified metric for a number of transmitted messages may be 500 transmitted messages representing that, e.g., 75% of the time (e.g., a predetermined percentile) 500 messages or less are transmitted before reaching consensus. As another example, a quantified metric for a number of attempts to reach consensus may be 2 attempts representing that, e.g., 80% of the time (e.g., a predetermined percentile) it would take 2 attempts or less to reach consensus. In some embodiments, the plurality of quantified metrics may include an average quantity for a first metric and a quantity representing a predetermined percentile for a second metric.

In step 308, the assessment system (e.g., metrics processor 224) provides a performance assessment of applying the PBFT-based consensus protocol in the permissioned blockchain network based on the plurality of quantified metrics.

In some embodiments, to provide the assessment, the assessment system can graph the expected time to reach consensus for a preselected set of network parameters for a range of validating nodes in the permissioned blockchain network. In these embodiments, the graph enables the user to visually view the number of nodes needed to maintain the blockchain network for the preselected network parameters.

In some embodiments, the assessment system can enable the user to perform what-if analysis on the plurality of network parameters to assess a performance of the permissioned blockchain network. In these embodiments, the assessment system can be configured to iteratively perform steps 304-308 for a plurality of sets of network parameters and graph the expected consensus time for each set of network parameters for a range of numbers of validating nodes in the permissioned blockchain network. For example, parameter selector 222 of FIG. 2 can select the set of network parameters to configure stochastic model 212 for each iteration executed by metrics processor 224.

In some embodiments, the assessment system receives, from the user, one or more service requirements 206 corresponding to one or more metrics from the plurality of metrics. In these embodiments, the assessment system can compare the plurality of quantified metrics calculated in step 306 against one or more of service requirements 206 to notify the user whether service requirements 206 can be met in view of the network parameters input by the user in step 302.

In some embodiments, the assessment system can vary values for a variable, e.g., a network parameter, to indicate to the user a required value for that variable to satisfy service requirements 206. For example, in step 302, the assessment system may receive, from the user, a specified network parameter to be assessed by the stochastic model. In some embodiments, this network parameter to be assessed may be an example of a type of assessment (i.e., one of assessment option 208). In some embodiments, to provide the performance assessment in step 308, the assessment system (e.g., parameter selector 222) selects a plurality of values for the specified network parameter. Then, the assessment system (e.g., metrics processor 224) may, for each value from the plurality of selected values, execute the stochastic model based on the selected value and the plurality of values corresponding to the plurality of network parameters to quantify the plurality of metrics. In some embodiments, based on the quantified plurality of metrics for each selected value, the assessment system can output a value for the specified network parameter required in the permissioned blockchain network to satisfy the one or more service requirements.

In some embodiments, to provide the performance assessment, the assessment system can be configured to generate a plurality of charts corresponding to the plurality of metrics, as will be further described below with respect to FIGS. 4A-B, 5A-B, and 6. In some embodiments, each chart may show changes in the metric across a range of a number of validating nodes for a plurality of values for the specified network parameter. Then, the assessment tool can be configured to display one or more of the plurality of charts.

FIGS. 4A-B, 5A-B, and 6 illustrate example charts that may be generated and displayed by an assessment system such as blockchain assessment application 200 of FIG. 2 to provide the user a performance assessment of a permissioned blockchain network, according to some embodiments. As discussed above, the efficiency of the permissioned blockchain network varies depending on the size of the network as specified by the number of validating nodes, the maximum number of byzantine faults that can be tolerated, and/or an average link latency (including queueing and transmission delays).

FIG. 4A illustrates a chart that shows the expected number of attempts to reach consensus for a number of tolerable faults (i.e., 1, 2, and 3) across a range of validating nodes (i.e., from 0 to 60) in the permissioned blockchain network, according to some embodiments. The packet dropping probability used to generate this chart is 0.4. In some embodiments, the chart of FIG. 4A may be an example output provided by the assessment system to the user.

As shown, to tolerate even a single fault (i.e., f=1), about 30 validating nodes are needed in the permissioned blockchain network to restrict the average number of attempts to 1.5 or less. To tolerate 2 faults, about 40 validating nodes are required to meet the same service requirement of an average number of attempts of 1.5 or less. In some embodiments, based on a service requirement (e.g., 1.5 seconds) and a blockchain parameter (e.g., tolerating 3 faults) provided by the user, the assessment system can determine and output to the user a minimum number of required validating nodes (e.g., 50 validating nodes to meet an average of 1.5 seconds while tolerating 3 faults). Alternatively, based on a service requirement (e.g., 1.5 seconds) and a number of validating nodes (e.g., 40) in the permissioned blockchain network under consideration, the assessment system can determine, based on the generated chart, that this network configuration can tolerate at most 2 faults.

FIG. 4B illustrates a chart that shows the expected number of attempts to reach consensus for a number of packet loss rates across a range of validating nodes in the permissioned blockchain network, according to some embodiments. The maximum fault tolerance used to generate this chart is 1. In some embodiments, the chart of FIG. 4B may be an example output provided by the assessment system to the user. As shown, the degradation of the permissioned blockchain network is negligible at lower packet loss rates, but as the packet loss rate increased, the degradation increases significantly. Similar to the example described with respect to FIG. 4A, the assessment system can provide the chart of FIG. 4B as an example output or the assessment system may derive a value for a network parameter or a number of validating node to meet the user's input service requirements.

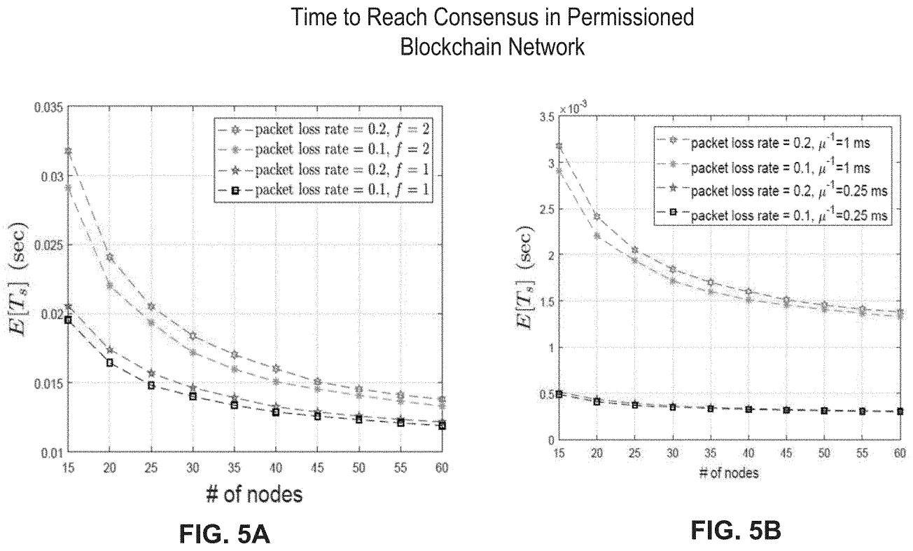

FIG. 5A illustrates a chart that shows the expected amount of time to reach consensus for a number of packet loss rates (i.e., 0.1 and 0.2) and a number of tolerable faults (i.e., 1 and 2) across a range of validating nodes (i.e., 15-60) in the permissioned blockchain network, according to some embodiments. In some embodiments, the chart of FIG. 5A may be an example output provided by the assessment system to the user. As shown, for a permissioned blockchain network with a packet loss rate of 0.1 and required to tolerate 2 faults, about 25 validating nodes are required to result in an average duration of 0.02 seconds to reach consensus.

FIG. 5B illustrates a chart that shows the expected amount of time to reach consensus for a number of packet loss rates (i.e., 0.1 and 0.2) and a number of average link latencies (1 ms and 0.25 ms) across a range of validating nodes in the permissioned blockchain network, according to some embodiments. In some embodiments, the chart of FIG. 5B may be an example output provided by the assessment system to the user. As shown, at low average latency (0.25 ms), the packet dropping rate has no impact on the performance for packet loss rates less than 20%. There is also minimal impact for average latency in the order of 1 ms. In some embodiments, the chart of FIG. 5B also reveals that impact of the average link latency can be significantly reduced by increasing the number of validating nodes. Accordingly, this chart generated by the assessment system may enable the user to perform what-if analysis for various network parameters that the user expects in the permissioned blockchain network being implemented or designed.

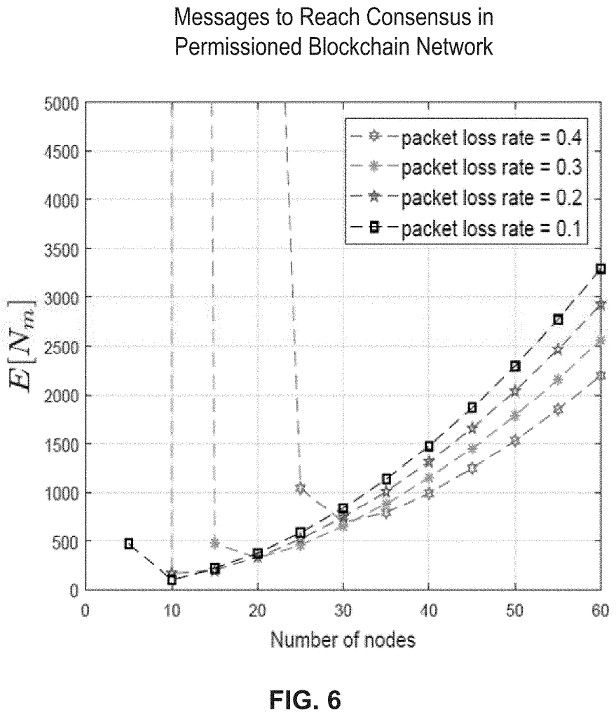

FIG. 6 illustrates a chart that shows the expected number of transmitted messages to reach consensus for a number of packet loss rates (i.e., 0.1, 0.2, 0.3, and 0.4) across a range of validating nodes in the permissioned blockchain network, according to some embodiments. In some embodiments, the chart of FIG. 6 may be an example output provided by the assessment system to the user. As shown, the average number of messages transmitted initially decreases and then increases with the number of validating peers. This is because, when there are fewer number of nodes, probability of successful consensus is also low, and from Equation (14), when p/pₛ is greater than one, the average number of messages increases exponentially with respect to the total number N of validating nodes. As shown in the chart, the minimum number of transmitted message occurs when p=pₛ. In some embodiments, the assessment system can be configured to determine and provide the user with this minimal point for a set of network parameters (e.g., a packet loss rate of 0.4) input by the user.

In some embodiments, by generating one or more of the graphs of FIGS. 4A-B, 5A-B, and 6, the assessment system enables the user to assess a minimum number of required validating nodes in a permissioned blockchain network to tolerate certain network conditions such as the number of byzantine faults (f) and/or to meet certain service requirements such as a maximum number of messages required to meet consensus.

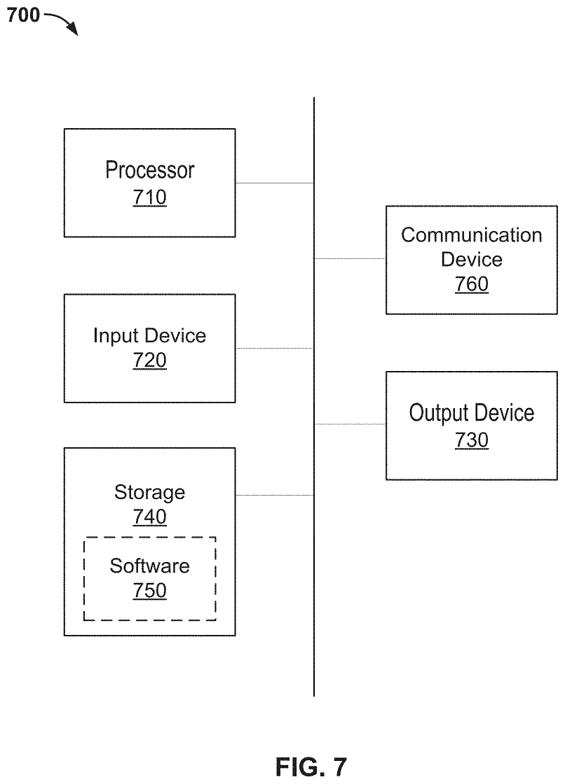

FIG. 7 illustrates an example of a computing device 700 in accordance with one or more examples of the disclosure. For example, device 700 may implement blockchain assessment application 200 as described above with respect to FIG. 2. Device 700 can be a host computer connected to a network. Device 700 can be a client computer or a server. As shown in FIG. 7, device 700 can be any suitable type of microprocessor-based device, such as a personal computer, workstation, server, or handheld computing device (portable electronic device), such as a phone or tablet. The device can include, for example, one or more of processor 710, input device 720, output device 730, storage 740, and communication device 760. Input device 720 and output device 730 can generally correspond to those described above, and they can either be connectable or integrated with the computer.

Input device 720 can be any suitable device that provides input, such as a touch screen, keyboard or keypad, mouse, or voice-recognition device. Output device 730 can be any suitable device that provides output, such as a touch screen, haptics device, or speaker.

Storage 740 can be any suitable device that provides storage, such as an electrical, magnetic, or optical memory including a RAM, cache, hard drive, or removable storage disk. Communication device 760 can include any suitable device capable of transmitting and receiving signals over a network, such as a network interface chip or device. The components of the computer can be connected in any suitable manner, such as via a physical bus or wirelessly.

Software 750, which can be stored in storage 740 and executed by processor 710, can include, for example, the programming that embodies the functionality of the present disclosure (e.g., as embodied in the devices described above).

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a web browser as a web-based application or web service, for example.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

What is claimed is:

1. A computer-implemented method for analytically assessing a permissioned blockchain network implementing a Practical Byzantine Fault Tolerance (PBFT) based consensus protocol, comprising:
receiving, from a user, a plurality of values corresponding to a plurality of network parameters specifying network constraints in the permissioned blockchain network;
configuring a stochastic model with the plurality of values, wherein the stochastic model comprises a plurality of probability mass functions (PMFs) corresponding to a plurality of sequential phases of the PBFT-based consensus protocol, wherein each PMF represents a probability distribution of numbers of validating nodes successfully receiving messages from validating nodes in a previous phase;
executing the stochastic model to quantify a plurality of metrics measuring a performance of the PBFT-based consensus protocol; and
providing a performance assessment of applying the PBFT-based consensus protocol in the permissioned blockchain network based on the plurality of quantified metrics.

2. The method of claim 1, wherein the plurality of network parameters comprises a number of validating nodes, a packet loss rate for data transfer between validating nodes, a maximum number of faulty validating nodes, and a link latency between validating nodes.

3. The method of claim 1, wherein the plurality of network parameters comprises a range of values for at least one network parameter.

4. The method of claim 1, wherein the plurality of metrics comprises an average number of attempts to reach a consensus within the permissioned blockchain network, an average amount of time to reach the consensus, and an average number of transmitted messages to reach the consensus.

5. The method of claim 1, wherein providing the performance assessment comprises:
receiving, from the user, one or more service requirements corresponding to one or more metrics from the plurality of metrics;
selecting a plurality of values for a number of validating nodes in the permissioned blockchain network;
for each selected value from the plurality of selected values, configuring and executing the stochastic model based on the selected value to quantify the plurality of metrics; and
based on the quantified plurality of metrics for each selected value, outputting a minimum number of validating nodes required in the permissioned blockchain network to satisfy the one or more service requirements.

6. The method of claim 1, wherein providing the performance assessment comprises:
receiving, from the user, one or more service requirements corresponding to one or more metrics from the plurality of metrics;
receiving, from the user, a specified network parameter to be assessed by the stochastic model;
selecting a plurality of values for the specified network parameter;
for each value from the plurality of selected values, configuring and executing the stochastic model based on the selected value and the plurality of values corresponding to the plurality of network parameters to quantify the plurality of metrics; and
based on the quantified plurality of metrics for each selected value, outputting a value for the specified network parameter required in the permissioned blockchain network to satisfy the one or more service requirements.

7. The method of claim 6, wherein providing the performance assessment comprises:
generating a plurality of charts corresponding to the plurality of metrics, wherein each chart shows changes in the metric across a range of a number of validating nodes for a plurality of values for the specified network parameter; and
displaying one or more of the plurality of charts.

8. A system for analytically assessing a permissioned blockchain network implementing a Practical Byzantine Fault Tolerance (PBFT) based consensus protocol, comprising:
one or more processors;
a memory storing one or more programs that when executed by the one or more processors cause the one or more processors to:
receive, from a user, a plurality of values corresponding to a plurality of network parameters specifying network constraints in the permissioned blockchain network;
configure a stochastic model with the plurality of values, wherein the stochastic model comprises a plurality of probability mass functions (PMFs) corresponding to a plurality of sequential phases of the PBFT-based consensus protocol, wherein each PMF represents a probability distribution of numbers of validating nodes successfully receiving messages from validating nodes in a previous phase;
execute the stochastic model to quantify a plurality of metrics measuring a performance of the PBFT-based consensus protocol; and
provide a performance assessment of applying the PBFT-based consensus protocol in the permissioned blockchain network based on the plurality of quantified metrics.

9. The system of claim 8, wherein the plurality of network parameters comprises a number of validating nodes, a packet loss rate for data transfer between validating nodes, a maximum number of faulty validating nodes, and a link latency between validating nodes.

10. The system of claim 8, wherein the plurality of network parameters comprises a range of values for at least one network parameter.

11. The system of claim 8, wherein the plurality of metrics comprises an average number of attempts to reach a consensus within the permissioned blockchain network, an average amount of time to reach the consensus, and an average number of transmitted messages to reach the consensus.

12. The system of claim 8, wherein to provide the performance assessment, the one or more processors are caused to:
receive, from the user, one or more service requirements corresponding to one or more metrics from the plurality of metrics;
select a plurality of values for a number of validating nodes in the permissioned blockchain network;
for each selected value from the plurality of selected values, configure and execute the stochastic model based on the selected value to quantify the plurality of metrics; and
based on the quantified plurality of metrics for each selected value, output a minimum number of validating nodes required in the permissioned blockchain network to satisfy the one or more service requirements.

13. The system of claim 8, wherein to provide the performance assessment, the one or more processors are caused to:
receive, from the user, one or more service requirements corresponding to one or more metrics from the plurality of metrics;
receive, from the user, a specified network parameter to be assessed by the stochastic model;
select a plurality of values for the specified network parameter;
for each value from the plurality of selected values, configure and execute the stochastic model based on the selected value and the plurality of values corresponding to the plurality of network parameters to quantify the plurality of metrics; and
based on the quantified plurality of metrics for each selected value, output a value for the specified network parameter required in the permissioned blockchain network to satisfy the one or more service requirements.

14. The system of claim 13, wherein to provide the performance assessment, the one or more processors are caused to:
generate a plurality of charts corresponding to the plurality of metrics, wherein each chart shows changes in the metric across a range of a number of validating nodes for a plurality of values for the specified network parameter; and
display one or more of the plurality of graphs.

15. A non-transitory computer-readable storage medium storing programming instructions that when executed by one or more processors causes the one or more processors to analytically assess a permissioned blockchain network implementing a Practical Byzantine Fault Tolerance (PBFT) based consensus protocol by:
receiving, from a user, a plurality of values corresponding to a plurality of network parameters specifying network constraints in the permissioned blockchain network;
configuring a stochastic model with the plurality of values, wherein the stochastic model comprises a plurality of probability mass functions (PMFs) corresponding to a plurality of sequential phases of the PBFT-based consensus protocol, wherein each PMF represents a probability distribution of numbers of validating nodes successfully receiving messages from validating nodes in a previous phase;
executing the stochastic model to quantify a plurality of metrics measuring a performance of the PBFT-based consensus protocol; and
providing a performance assessment of applying the PBFT-based consensus protocol in the permissioned blockchain network based on the plurality of quantified metrics.

16. The computer-readable storage medium of claim 15, wherein the plurality of network parameters comprises a number of validating nodes, a packet loss rate for data transfer between validating nodes, a maximum number of faulty validating nodes, and a link latency between validating nodes.

17. The computer-readable storage medium of claim 1, wherein the plurality of network parameters comprises a range of values for at least one network parameter.

18. The computer-readable storage medium of claim 1, wherein the plurality of metrics comprises an average number of attempts to reach a consensus within the permissioned blockchain network, an average amount of time to reach the consensus, and an average number of transmitted messages to reach the consensus.

19. The computer-readable storage medium of claim 1, wherein providing the performance assessment comprises:
receiving, from the user, one or more service requirements corresponding to one or more metrics from the plurality of metrics;
selecting a plurality of values for a number of validating nodes in the permissioned blockchain network;
for each selected value from the plurality of selected values, configuring and executing the stochastic model based on the selected value to quantify the plurality of metrics; and
based on the quantified plurality of metrics for each selected value, outputting a minimum number of validating nodes required in the permissioned blockchain network to satisfy the one or more service requirements.

20. The computer-readable storage medium of claim 1, wherein providing the performance assessment comprises:
receiving, from the user, one or more service requirements corresponding to one or more metrics from the plurality of metrics;
receiving, from the user, a specified network parameter to be assessed by the stochastic model;
selecting a plurality of values for the specified network parameter;
for each value from the plurality of selected values, configuring and executing the stochastic model based on the selected value and the plurality of values corresponding to the plurality of network parameters to quantify the plurality of metrics; and
based on the quantified plurality of metrics for each selected value, outputting a value for the specified network parameter required in the permissioned blockchain network to satisfy the one or more service requirements.

21. The computer-readable storage medium of claim 20, wherein providing the performance assessment comprises:
generating a plurality of charts corresponding to the plurality of metrics, wherein each chart shows changes in the metric across a range of a number of validating nodes for a plurality of values for the specified network parameter; and
displaying one or more of the plurality of charts.
